(19) United States
(12) Patent Application Publication
(10) Pub. No.: US 2024/0339630 A1
(43) Pub. Date: Oct. 10, 2024

(54) HIGH CONDUCTIVITY ANTI-PEROVSKITE SOLID ELECTROLYTES

(71) Applicant: UT-Battelle, LLC, Oak Ridge, TN (US)

(72) Inventors: Marm Dixit, Oak Ridge, TN (US); Ruhul Amin, Oak Ridge, TN (US); Rachid Essehli, Oak Ridge, TN (US); Ilias Belharouak, Oak Ridge, TN (US); Mahalingam Balasubramanian, Oak Ridge, TN (US); Nitin Muralidharan, Oak Ridge, TN (US)

(21) Appl. No.: 18/627,671

(22) Filed: Apr. 5, 2024

Related U.S. Application Data
(60) Provisional application No. 63/457,421, filed on Apr. 6, 2023.

(51) Int. Cl. H01M 6/18; H01M 10/0562

(52) U.S. Cl. CPC H01M 6/182; H01M 10/0562; H01M 2300/008

(57) ABSTRACT

A method of making an anti-perovskite solid electrolyte is provided. The method includes: providing an anti-perovskite material that is in the form of a powder; heating a die to a temperature between approximately 200 and 400° C.; loading the anti-perovskite powder into the heated die; compressing the anti-perovskite powder in the heated die; and allowing the heated die to cool to ambient temperature under pressure by maintaining the compression until the die has cooled to ambient temperature. The compression may be performed uniaxially and at a pressure in a range of 1 to 500 MPa. The anti-perovskite may undergo phase transformation, densification, and grain growth during compression at the elevated temperature. An anti-perovskite solid electrolyte formed by the method, and an anti-perovskite solid-state battery including the solid electrolyte are also provided.

### CROSS-REFERENCE TO RELATED APPLICATIONS

This application claims the benefit of U.S. Provisional Application No. 63/457,421, filed Apr. 6, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a method of making an anti-perovskite solid electrolyte for solid-state batteries and other applications.

### BACKGROUND OF THE INVENTION

Solid-state batteries (SSBs) may be able to achieve attain specific cell energy densities above 400 Wh/kg and 1200 Wh/L. However, obtaining working SSBs is hindered by significant materials and processing challenges, and the energy and power densities of SSBs fall short in comparison with state-of-the-art lithium-ion batteries. One challenge in bridging this gap lies in the development of practical and feasible thin, dense, solid electrolyte (SE) membranes that can be processed at scale. Additionally, the pathways for processing solid electrolytes dictate the local microstructures, pore distributions, grain sizes as well as lattice stress, which area critical to their performance. For example, the stochasticity of microstructure and phases within the bulk solid electrolyte strongly contributes to the failure modes of solid-state batteries. Thus, it is imperative to achieve a high degree of control over the microstructure of solid electrolytes to nullify this failure mode in solid electrolytes. On the other hand, there are limited approaches for achieving local control of microstructures during processing, especially for inorganic solid electrolyte materials. Particularly, there are fewer large-scale, high throughput processing approaches for inorganic materials, and they rely either on advanced sintering techniques or processing through slurry-based approaches. Further, none of these approaches provides active control of features like grain size, grain boundaries as well as porosity for inorganic solid electrolytes. Hence, the development of a processing pathway that can enable local control of microstructure and engineering of solid electrolytes at the grain scale is crucial for materializing high-performance all-solid-state batteries.

Solid electrolyte materials that have high ionic conductivities (>1 mS/cm) and transference numbers (close to unity), that can endure high critical current densities (>1 mA cm⁻²) with realistic thicknesses (<100 μm), and that have a stable electro-chemo-mechanical response during operation remain are a key component in SSBs. Anti-perovskites are a promising class of solid electrolytes due to their inherent low-temperature processability, high ionic conductivities, and high electrochemical stability window. Also, control of inter/intra granular pores, grain boundaries as well as lattice stress are potential ways of improving the ion transport in anti-perovskite materials. Further, development of tailored transport mechanisms and synthesis routes for anti-perovskite materials are needed to effectively assess the combinatorial phase space accessible in the anti-perovskite family. However, presently there continues to be a need to achieve controlled processing of anti-perovskite solid electrolyte materials.

### SUMMARY OF THE INVENTION

An improved method of making an anti-perovskite solid electrolyte is provided. The method includes providing an anti-perovskite material that is in the form of a powder. The method further includes heating a die to a temperature between approximately 200 and 400° C. The method next includes loading the anti-perovskite powder into the heated die. The method next includes compressing the anti-perovskite powder in the heated die. The method further includes allowing the heated die to cool to ambient temperature under pressure by maintaining the compression until the die has cooled to ambient temperature.

In specific embodiments, the step of compressing the anti-perovskite powder is performed at a pressure in a range of 1 to 500 MPa.

In specific embodiments, the method further includes the step of continuing to heat the die after loading the powder until a stable temperature is reached.

In specific embodiments, the anti-perovskite powder is compressed uniaxially in the die.

In specific embodiments, the die is one of a pellet die and an isostatic die.

In specific embodiments, the anti-perovskite powder has the chemical formula ABX₃, wherein X is a cation, A is oxygen or a hydroxyl group, and B is Cl, Br, F, I, or a combination thereof.

In particular embodiments, the anti-perovskite powder further includes an aliovalent dopant.

In specific embodiments, the anti-perovskite powder undergoes phase transformation together with densification during compression in the heated die.

In specific embodiments, the anti-perovskite powder undergoes grain growth during compression in the heated die.

An anti-perovskite solid electrolyte formed by the method is also provided.

In specific embodiments, the solid electrolyte is essentially free of pores.

In specific embodiments, the solid electrolyte has an average grain size of greater than 1 μm.

In specific embodiments, the solid electrolyte comprises a percolated cubic crystal structure.

In specific embodiments, the solid electrolyte has a high ionic conductivity of greater than 0.5 mS/cm at room temperature and greater than 1 mS/cm at elevated temperatures above approximately 40° C.

An anti-perovskite solid-state battery including the solid electrolyte is also provided.

These and other features of the invention will be more fully understood and appreciated by reference to the description of the embodiments and the drawings.

### BRIEF DESCRIPTION OF THE DRAWINGS

FIG. 1 is a schematic illustration of a method of making an anti-perovskite solid electrolyte in accordance with embodiments of the disclosure;

FIG. 2 is a graph of X-ray diffraction (XRD) patterns of synthesized anti-perovskite powder, a pellet formed from the powder by a conventional method, and a pellet formed from the powder by the method in accordance with embodiments of the disclosure;

FIG. 3 is a graph of XRD patterns of a pellet formed from the powder by a conventional method and a pellet formed from the powder by the method in accordance with embodiments of the disclosure, obtained by in-situ heating between 3° and 100° C.;

FIG. 4 is a graph of the XRD patterns of FIG. 3, zoomed in to reflections in the range of 30 to 35°;

FIG. 5 is a graph of X-ray photoelectron spectroscopy (XPS) survey spectra of a pellet formed from the powder by a conventional method and a pellet formed from the powder by the method in accordance with embodiments of the disclosure;

FIG. 6 is a graph of the F Is portion of the XPS spectra of FIG. 5;

FIG. 7 is a graph of the Li Is portion of the XPS spectra of FIG. 5;

FIG. 8 is a graph of the C Is portion of the XPS spectra of FIG. 5;

FIG. 9 is a graph of the O 1s portion of the XPS spectra of FIG. 5;

FIG. 10 is a graph of the Cl 2p portion of the XPS spectra of FIG. 5;

FIG. 11 is a graph of the N Is portion of the XPS spectra of FIG. 5;

FIG. 12 is a graph of surface concentrations of observed key chemical elements of the pellet formed from the powder by a conventional method and the pellet formed from the powder by the method in accordance with embodiments of the disclosure, as determined from the XPS survey spectra;

FIG. 13 is a graph of the total conductivity of the pellet formed from the powder by a conventional method and the pellet formed from the powder by the method in accordance with embodiments of the disclosure;

FIG. 14 is another graph of the conductivity of the pellet formed from the powder by a conventional method and the pellet formed from the powder by the method in accordance with embodiments of the disclosure;

FIG. 15 is a graph of critical current density (CCD) measurements of the pellet formed from the powder by a conventional method and the pellet formed from the powder by the method in accordance with embodiments of the disclosure;

FIG. 16 is a graph of electrochemical impedance spectroscopy (EIS) measurements of the symmetric cells before and after the CCD measurements shown in FIG. 15;

FIG. 17 is a graph of long-term polarization tests at 0.14 mA·cm⁻² for symmetric cells fabricated with the pellet formed from the powder by a conventional method and the pellet formed from the powder by the method in accordance with embodiments of the disclosure;

FIG. 18 is a graph of EIS measurements of the symmetric cells before and after the cycling shown in FIG. 17;

FIG. 19 is a graph of an impedance spectrum at 70° C. for the pellet formed from the powder by a conventional method;

FIG. 20 is a graph of an impedance spectrum at 70° C. for the pellet formed from the powder by the method in accordance with embodiments of the disclosure; and

FIG. 21 is a graph of distribution relaxation time (DRT) analyses computed from the corresponding impedance spectra of FIGS. 19 and 20.

### DETAILED DESCRIPTION OF THE CURRENT EMBODIMENTS

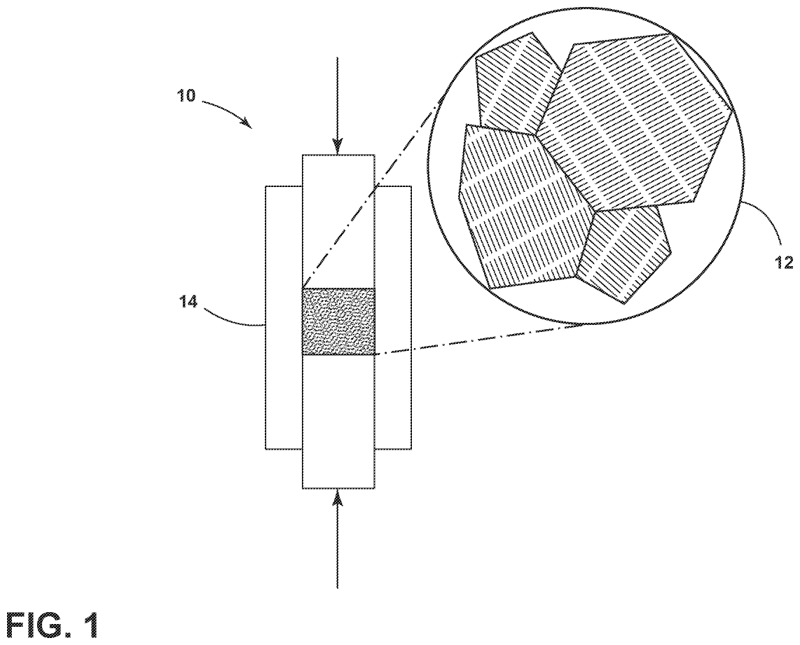

As discussed herein, the current embodiments relate to a method of manufacturing a solid electrolyte. As generally illustrated in FIG. 1, the method 10 includes providing an anti-perovskite material 12 in the form of a powder, heating a die 14 to a temperature between approximately 200 and 400° C., loading the anti-perovskite powder into the heated die, compressing the anti-perovskite powder in the heated die, and allowing the heated die to cool to ambient temperature under pressure by maintaining the compression until the die has cooled to ambient temperature. Each step is separately discussed below.

The method first includes providing an anti-perovskite material. In some embodiments, the anti-perovskite material may have the chemical formula ABX₃, wherein X is a cation such as lithium (Li), sodium (Na), another alkali metal, or similar, A is oxygen (O) or a hydroxyl group (OH), and B is a halide such as Cl, Br, F, I, or a combination thereof. In specific embodiments, the anti-perovskite material is LizOHR in which R is one of Cl, Br, F, I, or a combination of two or more of Cl, Br, F, and I. However, the anti-perovskite material is not limited to these particular chemical formulas, and may be any other anti-perovskite material. In general, an anti-perovskite, which also may be referred to as an inverse perovskite, has a crystal structure similar to a perovskite except that the sites occupied by the anions and cations are reversed. For example, in an anti-perovskite material the cation (such as an alkali metal, e.g. Li or Na) is at the face of an ideal cubic structure, and the anions are at the corners and center of the cubic structure. The anti-perovskite material may be obtained pre-made or may be synthesized from starting materials by any conventional solid-state synthesis process. Also, the anti-perovskite material may be obtained in powder form, or may be ground into a powder. Additionally, the anti-perovskite material may include an aliovalent dopant, i.e. may be subjected to aliovalent doping, that replaces some of the cation, e.g. substitutes for some of the lithium or sodium cation.

The method next includes heating a die to an elevated temperature between approximately 200 and 400° C., optionally between 20° and 300° C., optionally between 30° and 400° C., optionally between 20° and 250° C., optionally between 25° and 300° C., optionally between 30° and 350° C., optionally between 35° and 400° C., optionally between 20° and 225° C., optionally between 225 and 250° C., optionally between 25° and 275° C., optionally between 275 and 300° C., optionally between 30° and 325° C., optionally between 325 and 350° C., optionally between 35° and 375° C., optionally between 375 and 400° C. The die is not particularly limited, but preferably is capable of uniaxial compression. In some embodiments, the die is a pellet die or similar. In other embodiments, the die may be an isostatic die or similar.

The method next includes loading the anti-perovskite powder into the heated die. The amount of anti-perovskite powder loaded into the die is dependent on the size of the die. Optionally, the method may include the continual heating of the die after loading the powder until a stable temperature is reached. For example, when the anti-perovskite is loaded into the die.

The method next includes compressing the anti-perovskite powder in the heated die, such as by uniaxial compression. The pressure exerted on the anti-perovskite powder by the die may be in the range of 1 to 500 MPa, optionally between 1 and 50 MPa, optionally between 50 and 100 MPa, optionally between 100 and 150 MPa, optionally between 150 and 200 MPa, optionally between 200 and 250 MPa, optionally between 250 and 300 MPa, optionally between 300 and 350 MPa, optionally between 350 and 400 MPa, optionally between 400 and 450 MPa, optionally between 450 and 500 MPa. Alternatively, the pressure may be between 2 and 5 tons. Optionally, the method may include the continual heating of the die after loading the powder and initiating compression until a stable temperature is reached. For example, when the anti-perovskite is loaded into the die and compressed, the temperature may drop due to endothermic structural changes to the compressed powder. In such cases, the heater controller may continue to operate and deliver heat to the die until the temperature is stable.

While continuing to maintain the compression pressure on the anti-perovskite material present within the die, heating of the die is ceased (e.g., the heater that heats the die is shut off, such as by a temperature controller) and the die is allowed to cool to ambient temperature (e.g., room temperature such as approximately 20 to 25° C.) under pressure. Once the die has reached ambient temperature, the solid electrolyte product (e.g., anti-perovskite pellet) is removed from the die by relieving the pressure and opening the die. The resulting anti-perovskite solid electrolyte is a translucent pellet, whereas pellets obtained by conventional cold pressing processes are white, opaque pellets. The combined heat-pressure compression of the anti-perovskite powder and subsequent cooling under pressure enables a high degree of local control over the grain growth within the anti-perovskite solid electrolytes, and particularly leads to greater grain growth than in conventional cold formation processes in which the heating of the die is not performed. Specifically, the anti-perovskite solid electrolyte obtained by the present method may have, for example, an average grain size in excess of 1 μm, optionally greater than 5 μm, optionally greater than 10 μm, optionally greater than 15 μm, optionally greater than 20 μm, optionally greater than 25 μm, optionally greater than 30 μm, optionally greater than 35 μm, optionally from 40 to 60 μm. Further, the resulting anti-perovskite solid electrolyte is essentially porosity-free and has highly improved total conductivity in comparison to solid electrolytes formed by conventional processes. As shown in more detail in the example below, the presently obtained anti-perovskite solid electrolyte has a conductivity of greater than 0.5 mS/cm at room temperature and greater than 1 mS/cm at elevated temperatures. The increase in total conductivity is likely due to higher densities, larger grain sizes, and more conductive cubic phases within the presently obtained anti-perovskite solid electrolytes.

The presently obtained anti-perovskite solid electrolytes having these properties including the high conductivity make the obtained product a highly desirable solid electrolyte for solid-state batteries. Further, the present method disclosed herein can be extended beyond uniaxial compression to other compression techniques such as isostatic pressing, providing for scalability of the present method. Thus, the present method may be used for large-scale processing of inorganic solid electrolytes while maintaining control over microstructures that is essential to mitigate failure in solid electrolytes.

### EXAMPLE

The present method is further described in connection with the following laboratory example, which is intended to be non-limiting.

LizOHCI was synthesized using a conventional solid-state synthesis approach. LiOH and LiCl were sourced from Thermo-Fisher and dried extensively prior to use. These materials were mixed in stoichiometric amounts and ground together to form a homogenous mixture. The mixture was then heated in a furnace in a step-heating protocol to a maximum temperature of 350° C. and allowed to cool back to room temperature. The resultant material (“synthesized powder”) was hand-grinded and used for further experiments. Subsequently, conventionally processed pellets were made by loading 0.3 g of the synthesized powder into a 12.5 mm diameter stainless steel die. The synthesized powder was uniaxially pressed in the die to a pressure of 5 tons (conventional protocol) to form the pellet. The pellet was used for subsequent testing after polishing the surfaces. For the moderate temperature protocol (method disclosed herein), a 12.5 mm die was heated to a temperature between 25° and 300° C. Subsequently, an equivalent amount of the synthesized powder was loaded into the die and pressurized to 5 tons. The controller to the heater of the die was left on until a stable temperature was reached on the die, after which the heater/controller was turned off. Particularly, it was observed during this processing that the introduction of the powder to the heated die resulted in an immediate drop in temperature even when the temperature controller is active. The temperature decreased continued until it stabilized at ˜150° C., at which point the controller was turned off. The setup was then allowed to cool to room temperature (ambient conditions) under pressure. After the die reached room temperature, the pellet was extracted from the die and the surfaces were polished to a mirror finish.

Temperature reduction during moderate temperature processing has not been previously observed for any solid electrolyte materials. This strongly indicates that the controlled temperature evolution of the present method has strong links to the resultant pellet, its microstructure, and its ionic conductivity properties. The present method is strongly coupled to the phase transformation process that the anti-perovskite materials undergo from the orthorhombic to cubic phases. This endothermic phase transformation along with potential grain growth may lead to the improvement in density and conductivity of the anti-perovskite solid electrolyte material obtained by the present method.

X-Ray tomography studies were carried out on the samples at the 2-BM beamline of the Advanced Photon Source with a resolution of ˜1.5 μm. These ex-situ tomography measurements on the conventional pellets and the present pellets showed a stark difference in the microstructures. The conventional pellets showed ˜12% porosity when evaluated over the entire field of view, with pore sizes ranging from several μm to 100 s of μm. On the other hand, there were no discernible features in the pellets made according to the present method. This suggests that the present, high-temperature processed pellet have a very high density (˜100% as estimated from the tomography data). Achieving this level of density in a single-step process is a key advantage over conventionally processed materials either through uniaxial pressing or sintering.

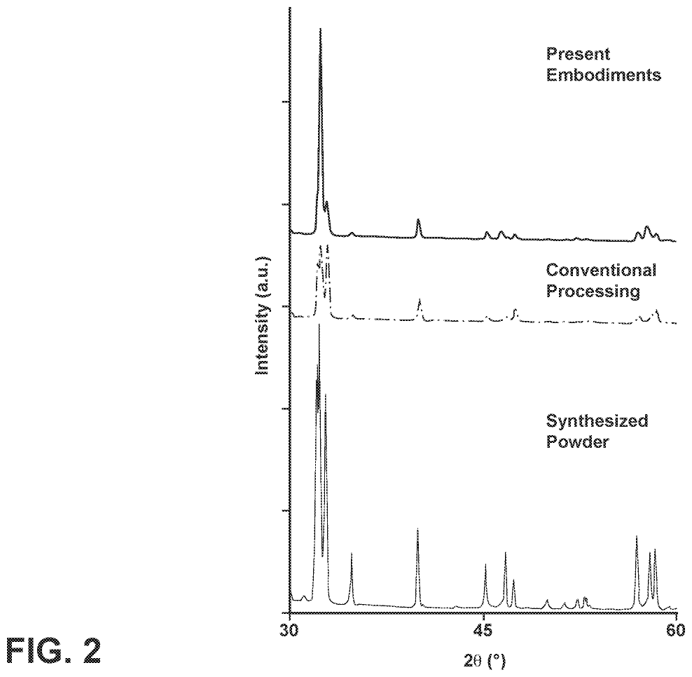

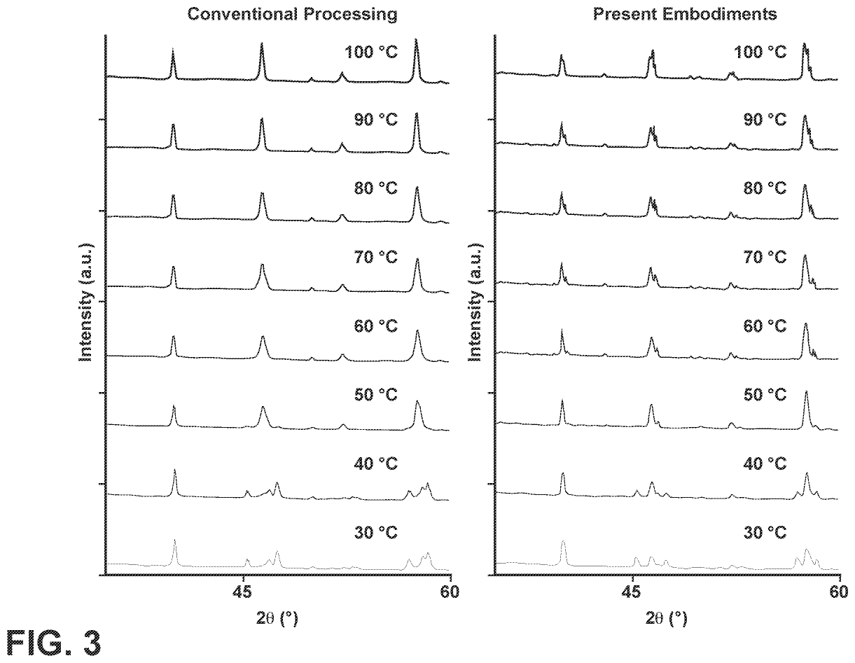

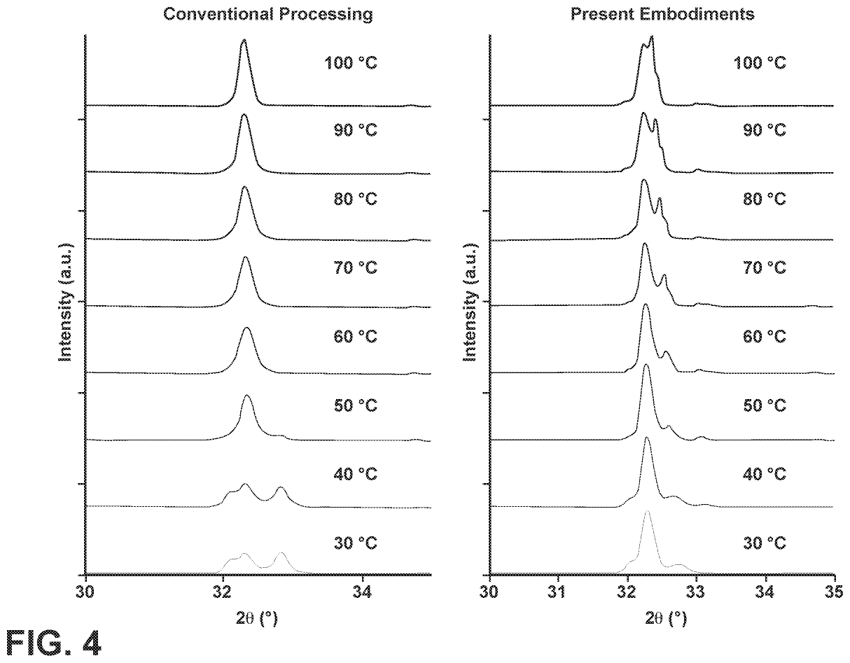

X-ray diffraction (XRD) patterns of the samples were carried out using a Panalytical Empyrean Diffractometer employing Cu Ka radiation at 45 kV and 40 mA conditions. The data were collected at room temperature over the 20 angle range of 30 to 60° with a step size of 0.01°, and the results are shown in FIG. 2. The samples were covered by Kapton film and tightened by a PTFE O-ring to avoid any reaction with moisture and oxygen. For in-situ heating experiments to further evaluate the phase stability of the materials, a custom heated stage was introduced in the diffraction instrument, and spectra were collected between 3° and 100° C. These results are shown in FIGS. 3 and 4. The XRD pattern of the material made according to the present method confirmed the high purity and crystallinity of the so-processed anti-perovskite LizOHCI material. Full pattern matching was performed with the Jana2006 program package and refinement indicated that the conventionally-processed material had an orthorhombic (rhombohedral) crystal structure with space group Pban and a primary crystallite size estimated from the peak widths to be around 26 nm. Also, LiCl (cubic Fm-3m) and Li₄(OH)₃Cl (monoclinic P21/m) were observed as minor impurity phases. When the temperature increased beyond 40° C., a phase transformation to cubic symmetry with a space group (Pm-3m) was observed. On the other hand, the moderate temperature processed pellet according to the present method showed the presence of a cubic phase along with the orthorhombic phase, although no similar phase transformation was observed. Further, a comparison of the FWHM for the first reflection revealed that the peak width was decreased by half from ˜0.4° to ˜0.2° from the conventional processed material to the moderate temperature processed material according to the present method. This result indicates an increase in the crystallite sizes obtained by the present temperature-pressure process which is consistent with other experimental data herein.

To further assess the structural differences between the conventional material and the material made according to the present method, transmission electron microscopy (TEM) with selected area electron diffraction (SAED) measurements were carried out. Both materials were dry-loaded onto lacey carbon TEM grids and onto a TEM holder in an argon (inert) atmosphere glove box. The TEM holder was transferred to a microscope in an inert atmosphere bag but exposed to ambient air for the loading process, a couple of seconds for insertion followed by ˜5 minutes being evacuated before reaching the column vacuum. Both samples were dry-transferred onto the TEM grid. The processed pellet was ground with a mortar and pestle in the glove box immediately prior to loading. TEM was carried out on a Thermo Fischer Titan at 300 kV. A nanocrystalline structure in the particles was apparent both from TEM images and the rings in the corresponding SAED patterns. Both samples exhibited visible degradation under the 300 kV electron beam at higher magnifications, but appeared stable for the timescale of the experiments for the lower dose low mag imaging and diffraction. In addition to the nanoparticle rings, the SAED pattern from the conventional material exhibited a grid of bright Bragg spots from a large single-crystal particle. The fully matched d-spacings are indicative of a mixed-scale of isostructural particles. Such large single-crystal particles were much more prevalent for the parent compound. However, it is unknown from the TEM alone how well this reflects innate differences or differences in TEM loading from having to grind the processed pellet. Radially integration of the electron diffraction patterns showed several matched position peaks, notably the highest intensity ring, but also clear distinctions indicative of a phase change or new phase(s). This includes a slight peak shift towards higher radial Q for the moderate-temperature-processed material which is consistent with the data obtained from the bulk XRD measurements. The moderate-temperature processed material showed a higher number of reflections compared to the as-synthesized conventional powder suggesting either a lower degree of symmetry or mixed phases. This behavior was observed over multiple locations consistently on both samples. Overall, the XRD and SAED measurements show that the present moderate-temperature-processed enables the stabilization of a mixture of cubic and orthorhombic phases at room temperature that can contribute to the improvement of the transport properties.

Scanning electron microscopy (SEM) and energy dispersive x-ray spectroscopy were carried out using a ThermoFisher Scios 2 FIB-SEM instrument. X-ray photoelectron spectroscopy (XPS) was conducted on a Thermo Scientific ESCA Lab 250Xi. All the spectra were charge-corrected relative to the C—C peak at 284.8 eV. The SEM images showed the presence of larger grains in the moderate-temperature-processed pellets indicating fewer grain boundaries within this material, which can significantly augment the transport properties of the present anti-perovskite solid electrolytes obtained by the method. The grain boundaries can also affect the performance of solid electrolytes by acting as concentrators of stresses due to their disparate mechanical properties. The SEM images of the conventional and moderate-temperature-processed pellets also show that the conventional pellets have porous features both on the surface as well as the cross-section, in the form of individual particles of the order of ˜μm, and pore sizes ranging in 10 s to 100 s of μm on the surface as well as the cross-section. This is also consistent with the results obtained from the X-ray tomography data which showed a porous structure with pore sizes within that range. In contrast, the moderate-temperature processed material showed an extremely dense structure with no discernible pores. Surface morphology at low magnifications showed large vein-like features that could potentially be grain boundaries. No preferential alignment of the domains was observed on the surface, but the average sizes are typical of the order of 40-60 μm. At higher magnification, needle-like features were observed uniformly across the surface that could represent individual crystallite domains that make up a grain. Elemental distribution maps showed a uniform distribution of the constituent elements across the imaged area.

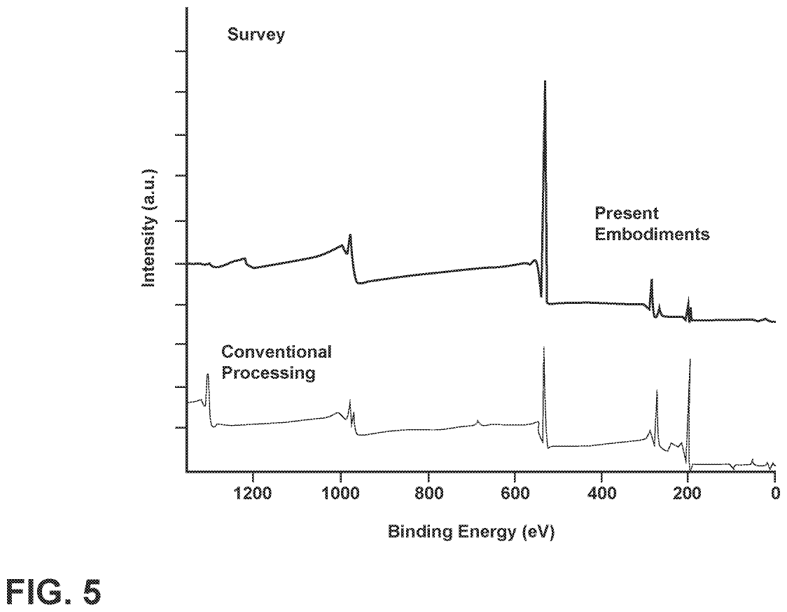

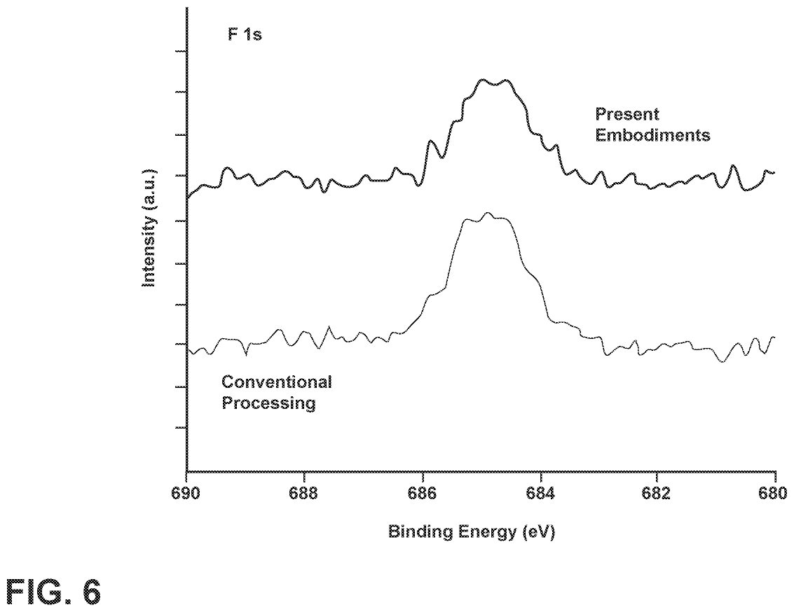

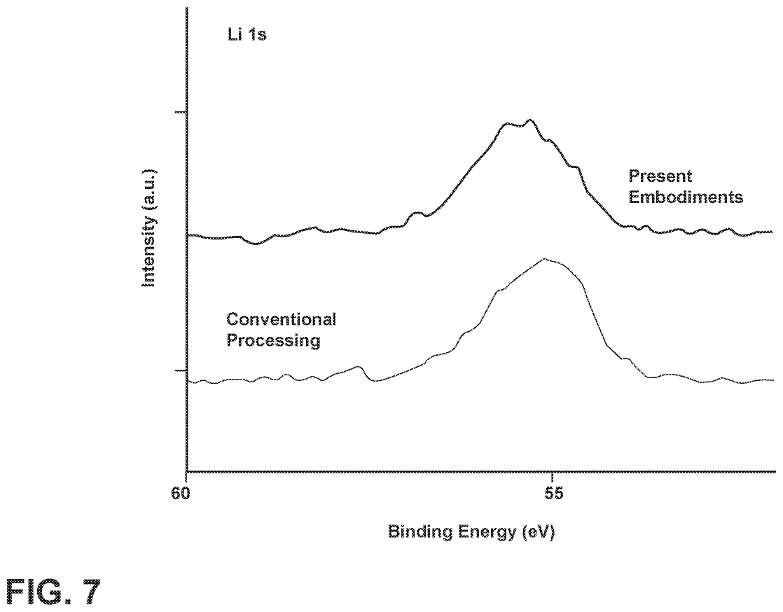

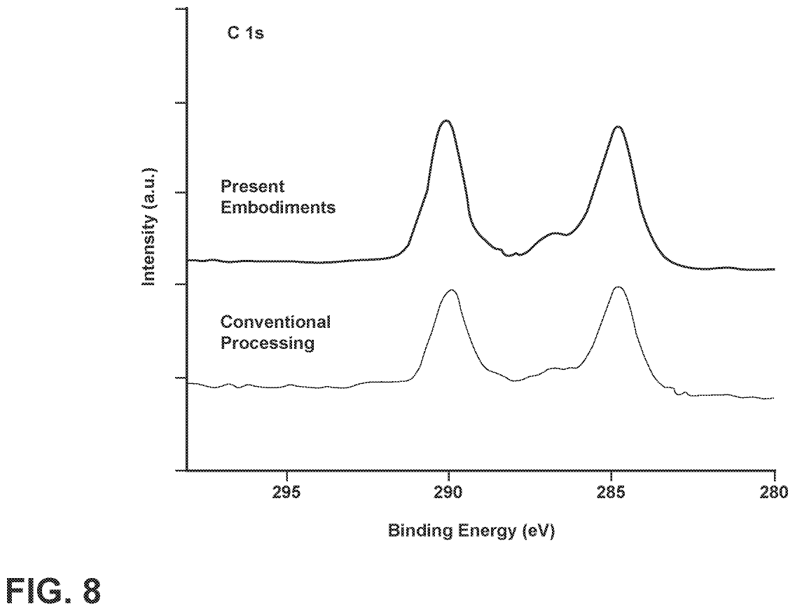

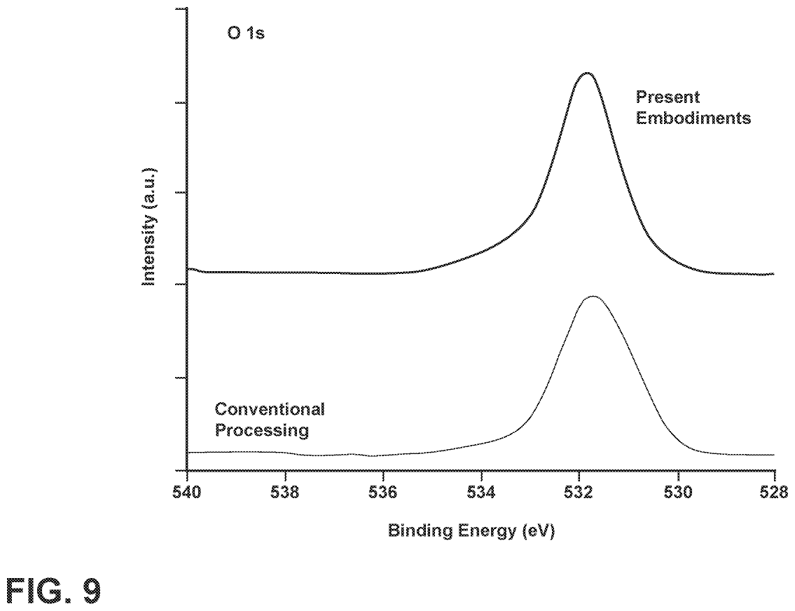

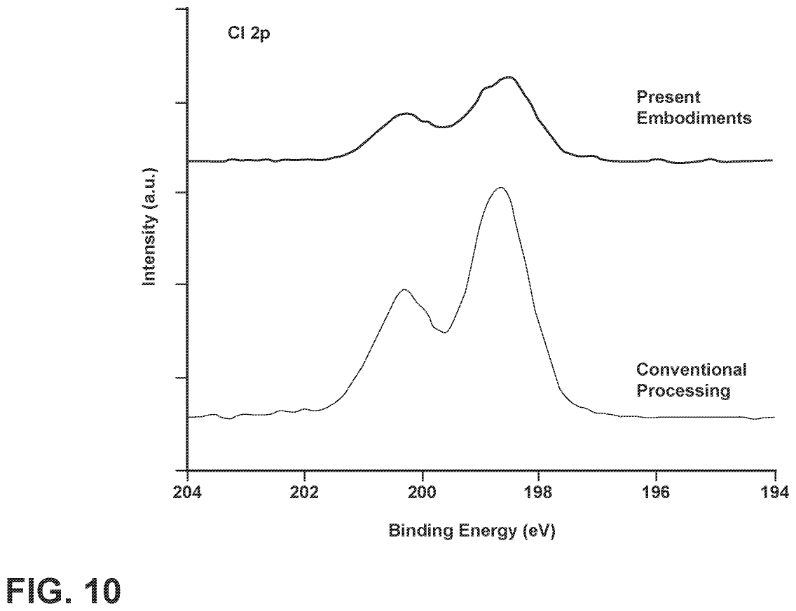

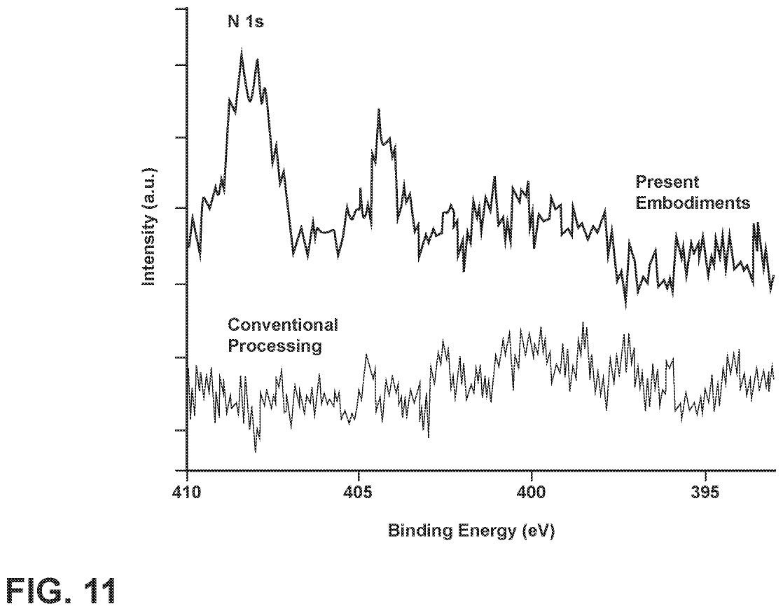

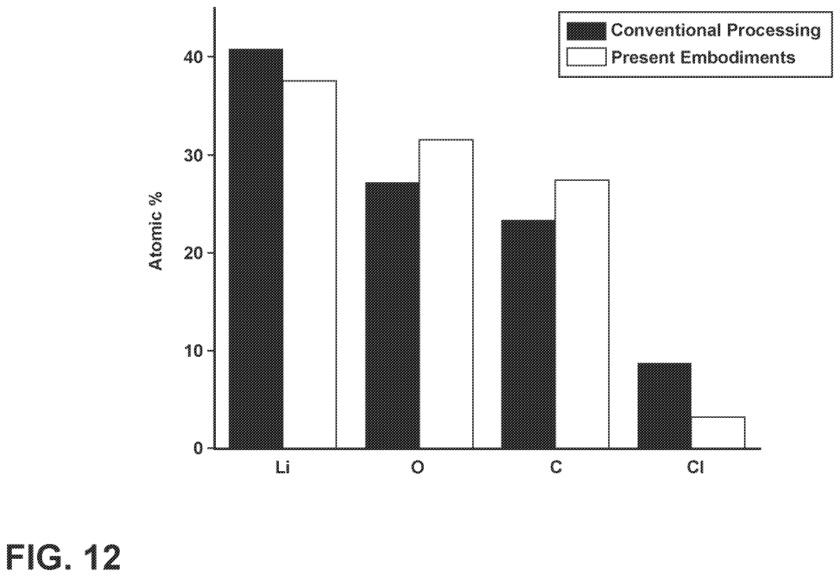

The XPS data illustrated the chemical composition of the surface of the conventional pellets and the pellets formed according to the present method. From the impedance spectra of the symmetric cells (see below), it was observed that the Li| SE interfacial resistance was much lower for the moderate-temperature-processed material. In addition to surface roughness and morphology, chemical speciation can also affect this behavior. As shown in FIGS. 5-10, the XPS survey spectra showed that there are signals for Li, Cl, C, and O on the surface in addition to the presence of F as a contaminant. The F Is spectra indicated the formation of LiF on the surface with a peak at BE of 684.8 eV, which could have originated from contamination in the glove box. The presence of N species on the surface of the pellet processed with the moderate-temperature-protocol was also observed. As shown in FIG. 11, the N Is spectrum, found only on the pellets formed according to the present method, showed two distinct peaks at 404.3 eV and 408.1 eV, indicative of Li—N and Li—N—O bonds, respectively. The occurrence of N on the present pellets only can be explained by the fact that the processing was carried out in a dry room which could lead to the fixation of nitrogen on the surface of these materials. More importantly, as shown in FIG. 12, the inorganic surface elements (Li and Cl) of the pellet processed with the present moderate-temperature-protocol are considerably higher. This is indicative that the conventional pellet is covered with a thicker layer of carbonaceous content. Both Cl Is spectra for the two differently prepared pellets have the same oxidation state peaks, at BEs of 198.6 eV and 200.3 eV, representative of Li—Cl and Cl—C species, respectively. Finally, the surface concentrations of the contaminants are <1 at. % for the two pellets. The XPS data suggests that the moderate-temperature-process pellets can be effectively used to introduce surface moieties with minimal processing requirements.

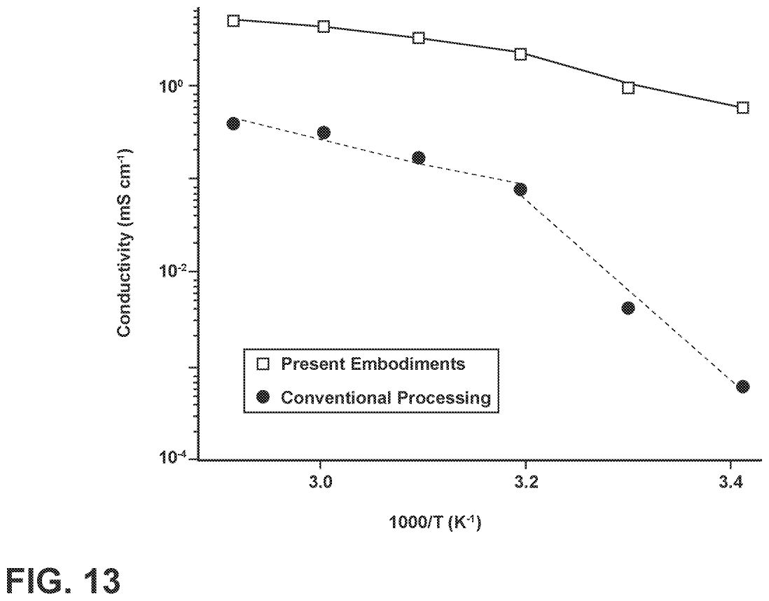

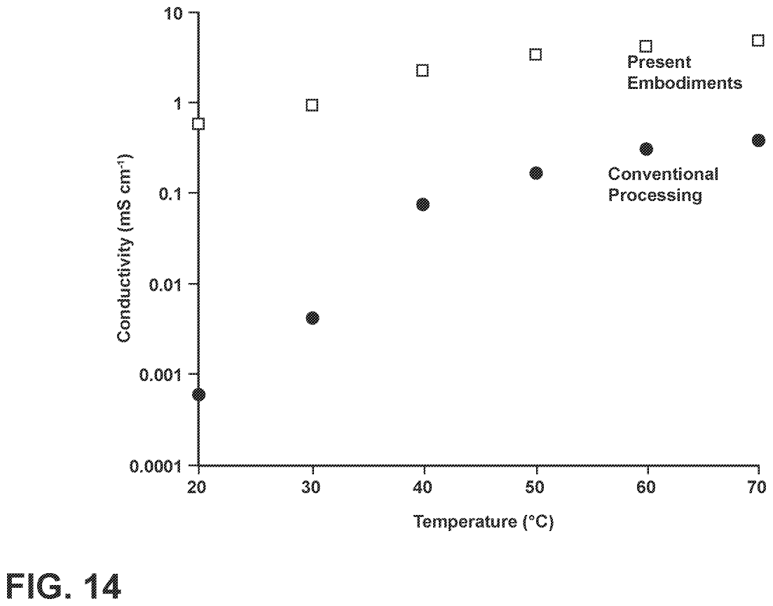

Conductivity measurements were carried out using a blocking electrode setup. Impedance spectra were recorded between 25 and 70° C. using a Biologic VMP3 instrument between a 7 MHz and 100 mHz frequency range with a 10 mV amplitude. For symmetric cells, Li metal foils were pressed on the surface of the pellets and the resultant assembly was pressurized in a split PEEK cell set up and kept in a temperature chamber maintained at 70° C. for subsequent measurements. As shown in FIG. 13, the material formed according to the present method (moderate-temperature-processed material) exhibited almost three orders magnitude higher conductivity than the conventionally processed sample at room temperature, and at the higher temperature intervals this difference is almost one order of magnitude. Further, as shown in FIG. 14, the conductivity was measured between 2° and 70° C. for both the conventional and the present processing methods. For the conventional method, two mechanisms for ion conduction between 2° and 70° C. were observed. In contrast, the material made according to the present method showed a flat conductivity profile across the temperature range with apparently lower activation energy. The room temperature conductivity for the present moderate-temperature-processed material (0.58 mS cm−1) is several orders of magnitude higher than that of the conventionally-processed material (6.11×10−4 mS cm−1). At 70° C., the present moderate-temperature-processed material showed a high conductivity of 5 mS cm−1 w. Higher conductivity for the moderate-temperature-processed material may stem from the increased densification, changes in the grain/grain boundaries of the material as well as from structural changes. The activation energies of the lower and higher temperature slopes are 1.90 eV and 0.51 eV for the conventionally processed material, respectively, and are 0.52 eV and 0.24 eV for the moderate-temperature-processed material, respectively. It is widely established that anti-perovskite materials undergo a phase-transformation into a cubic phase at ˜50° C. and such a transformation may increase the ionic mobility and decrease the migration energy which is the case in both materials. The obtained activation energies are consistent with previously reported data.

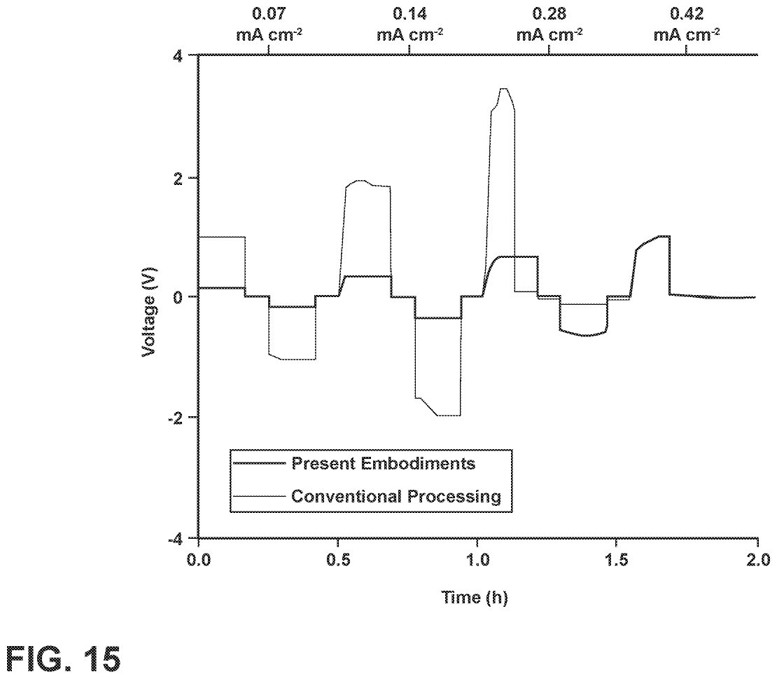

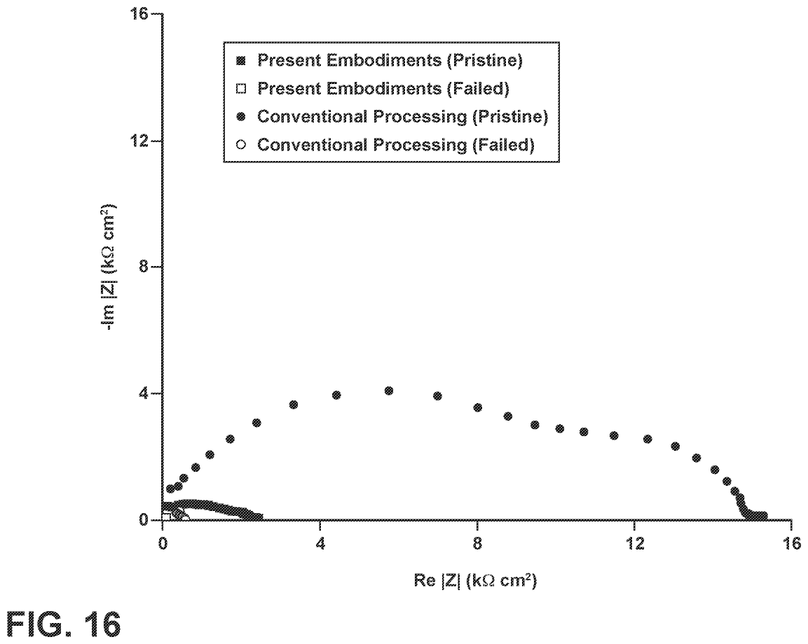

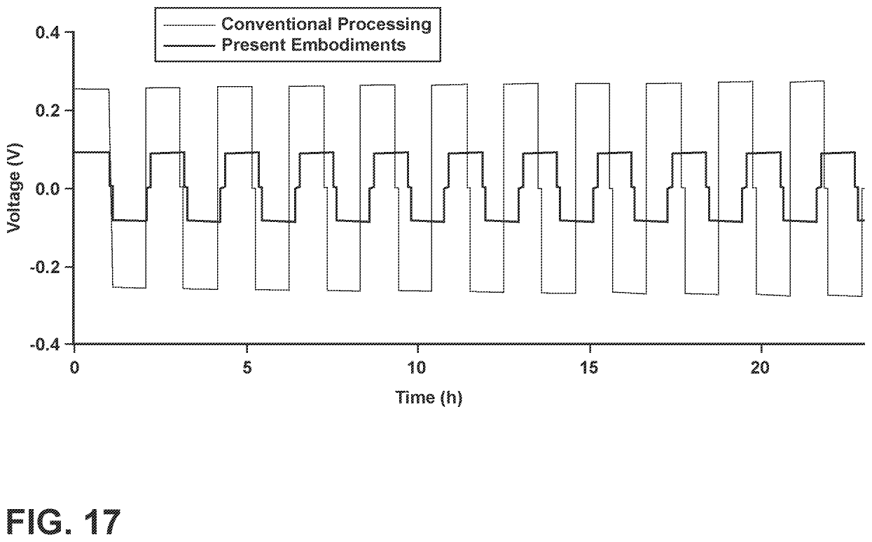

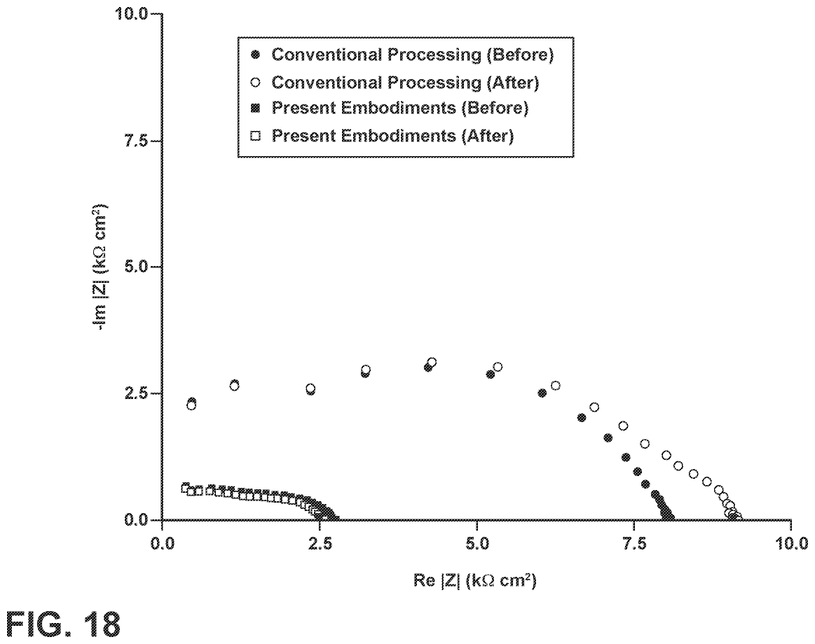

Critical current density measurements were also performed with symmetric Li|LiOHCl|Li cells. Critical current density is generally a measure of the maximum current that can be drawn from a symmetric cell without shorting the cell (polarization falling to low values). As shown in FIG. 15, the critical current density of the conventionally pressed pellets was 0.28 mA cm⁻² while for the moderate-temperature-processed pellet it was 0.42 mA cm⁻² showing nearly a 50% improvement in the CCD value. These CCD numbers are at par or better than those previously reported for anti-perovskite materials. The polarization profiles during the measurements remained relatively flat showing a stable interphase between Li metal and the anti-perovskite. As shown in FIG. 16, the impedance spectra were also measured for the assembled and the failed symmetric cells for the two systems. At similar stack pressure and operating temperatures, the Li|SE interfacial resistance was significantly higher (˜8×) for the conventionally processed solid electrolyte compared to the present moderate-temperature-processed material. This suggests an inherent change in the lithium wettability of the surface of the moderate-temperature-processed material. The cell resistance of the moderate-temperature-processed material was ˜2.5 k (2 cm² which is comparatively higher than what has been reported for other inorganic solid electrolytes. However, further optimization of the assembly and operating conditions may lower this value leading to an improvement in the CCD performance. As shown in FIGS. 17 and 18, long-duration testing of the symmetric cell was also performed to evaluate the performance of the two processing approaches. At similar current density, the moderate-temperature-processed material showed much lower polarization compared to the conventionally processed material. This is directly linked to the Li|SE interfacial resistance which is higher for the conventionally processed material. Also, after cycling, the Li|SE interfacial resistance increased for the conventionally processed material while it showed a slight decrease for the moderate-temperature-processed material. This indicated a possible deterioration of the interfacial contact for the former material system over time during cycling which is known to lead to filament formation on extended cycling.

Distribution of Relaxation Time Analysis (DRT) was performed to further delineate the origin of the improvement in the transport properties and the electrochemical performance of the conventional pellets and the pellets made according to the present method. For DRT, the impedance spectra are fitted with many RC circuits with each pair possessing a defined characteristic time constant. The mathematical formulation between the impedance spectrum Z (@) and the DRT y (t) is given as follows:

$$Z ( ω ) = {R}_{0} + {\int }_{0}^{∞} \frac{γ ( τ )}{1 + j ωτ} d τ$$

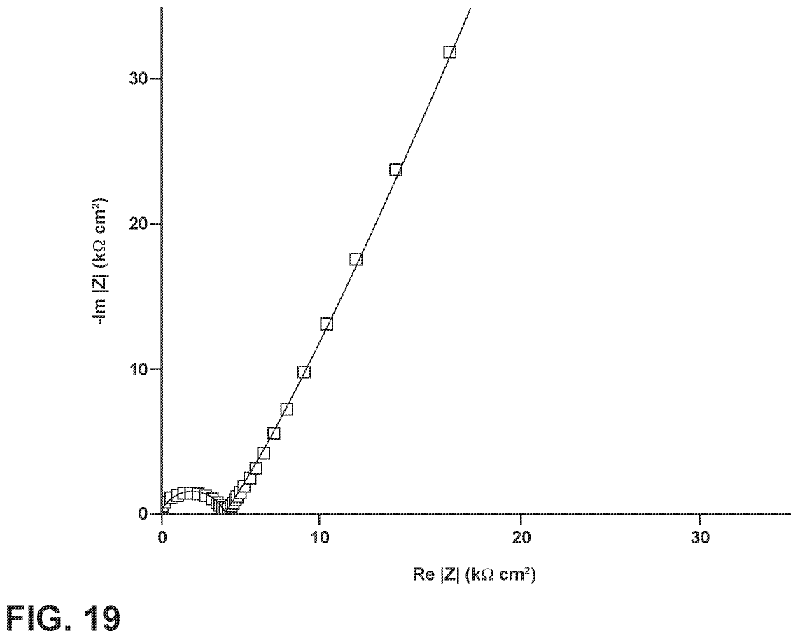

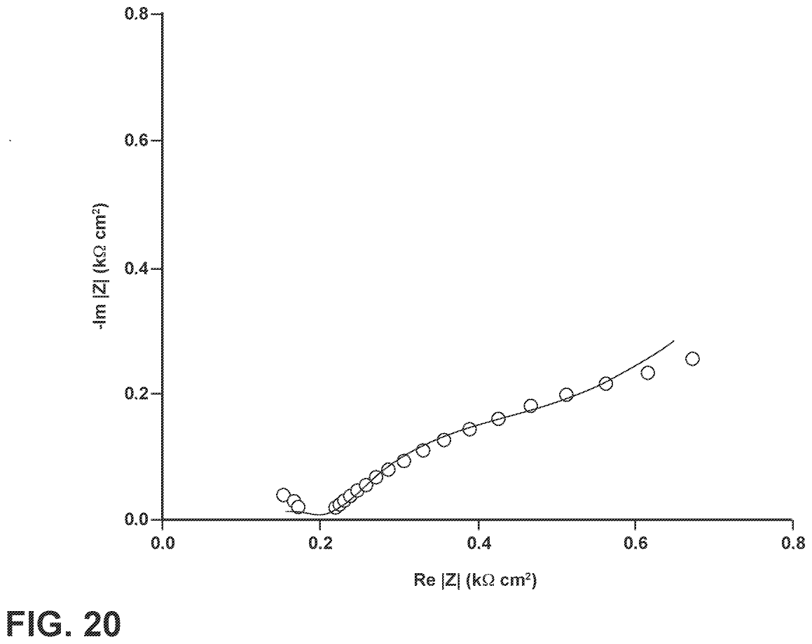

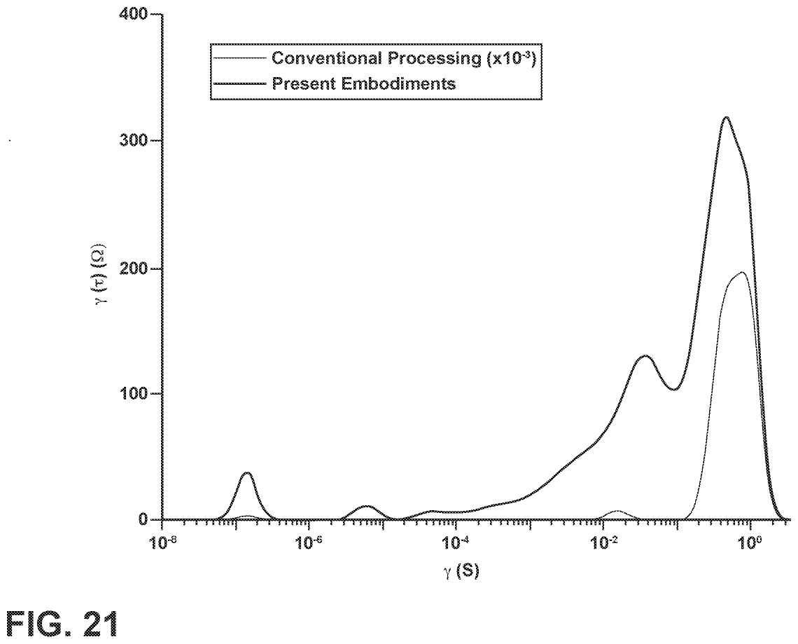

This equation is solved using a fitting approach through a MATLAB tool. The equivalent circuit fitting results for the two impedance spectra (see FIGS. 19 and 20) are detailed in Tables 1 and 2 below, which were obtained with a blocking electrode setup for the two materials at 70° C. The DRT analysis illustrated in FIG. 21 clearly showed evidence that the present moderate-temperature-processing method occurred at smaller relaxation times, i.e. was a faster process. With the moderate temperature processed material, a distribution of features was observed at relaxation times ranging from 10⁻⁴ to 10⁻² s, and another feature at 10⁻⁵ to 10⁻⁶ s. Such behavior is typically identified to be from grain boundaries that possess improved transport properties or could arise from secondary cubic phases. A very clear difference in the spectra themselves were observed wherein the conventional pellet showed a single semi-circle at high frequency followed by a diffusion tail, while the moderate-temperature-processed material showed several semi-circles at higher and moderate frequencies followed by the diffusion tail. The former likely combines the bulk and grain boundary resistance into a single lumped ionic behavior while the latter can explicitly model the grain and grain boundary contributions. The peak at ˜100 s is associated with the blocking electrodes employed for the testing and the feature at ˜10⁻²/10⁻³ s is associated with the SE| current collector interface. The feature at 10⁻⁷ s is associated with the Lit migration in the bulk material and is related to the fundamental hopping mechanism of ion transport within the matrix.

TABLE 1
Equivalent Circuit Fitting of the Impedance Spectra of Conventionally
Processed Anti-Perovskite Material at 70° C.

| Equivalent Circuit | R1 + C2/R2 + C3/R3 + W4 | |
|---|---|---|
| R1 | 7.652e−12 | Ohm |
| C2 | 2.324e−6 | F |
| R2 | 261288 | Ohm |
| C3 | 40.49e−12 | F |
| R3 | 3243 | Ohm |
| S4 | 45258 | Ohm · s\hat{ }-1/2 |

TABLE 2
Equivalent Circuit Fitting of the Impedance Spectra of Present Moderate-
Temperature-Processed Anti-Perovskite Material at 70° C.

| Equivalent Circuit | R1 + Q2/R2 + Q3/R3 + Q4/R4 + W5 | |
|---|---|---|
| R1 | 34.79 | Ohm |
| C2 | 3.32e−6 | F · s\hat{ }(a − 1) |
| a2 | 0.4869 | |
| R2 | 46.13 | Ohm |
| Q3 | 0.1624e−3 | F · s\hat{ }(a − 1) |
| a3 | 0.8479 | |
| R3 | 161.6 | |
| Q4 | 1.34-3 | F · s\hat{ }(a − 1) |
| A4 | 0.07911 | |
| R4 | 200.9 | Ohm |
| S5 | 654.9 | Ohm · s\hat{ }-1/2 |

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of making a solid electrolyte, the method comprising:
providing an anti-perovskite material, wherein the anti-perovskite material is in the form of a powder;
heating a die to a temperature between approximately 200 and 400° C.;
loading the anti-perovskite powder into the heated die;
compressing the anti-perovskite powder in the heated die; and
allowing the heated die to cool to ambient temperature under pressure by maintaining the compression until the die has cooled to ambient temperature.

2. The method of claim 1, wherein the step of compressing the anti-perovskite powder is performed at a pressure in a range of 1 to 500 MPa.

3. The method of claim 1, including the step of continuing to heat the die after loading the powder until a stable temperature is reached.

4. The method of claim 1, wherein the anti-perovskite powder is compressed uniaxially in the die.

5. The method of claim 1, wherein the die is one of a pellet die and an isostatic die.

6. The method of claim 1, wherein the anti-perovskite powder has the chemical formula ABX₃, wherein X is a cation, A is oxygen or a hydroxyl group, and B is Cl, Br, F, I, or a combination thereof.

7. The method of claim 6, wherein the anti-perovskite powder further includes an aliovalent dopant.

8. The method of claim 1, wherein the anti-perovskite powder undergoes phase transformation together with densification during compression in the heated die.

9. The method of claim 1, wherein the anti-perovskite powder undergoes grain growth during compression in the heated die.

10. An anti-perovskite solid electrolyte formed by the method of claim 1.

11. The anti-perovskite solid electrolyte of claim 10, wherein the anti-perovskite has the chemical formula ABX₃, wherein X is a cation, A is oxygen or a hydroxyl group, and B is Cl, Br, F, I, or a combination thereof.

12. The anti-perovskite solid electrolyte of claim 11, wherein the anti-perovskite powder further includes an aliovalent dopant.

13. The anti-perovskite solid electrolyte of claim 10, wherein the solid electrolyte is essentially free of pores.

14. The anti-perovskite solid electrolyte of claim 10, wherein the solid electrolyte has an average grain size of greater than 1 μm.

15. The anti-perovskite solid electrolyte of claim 10, wherein the solid electrolyte comprises a percolated cubic crystal structure.

16. The anti-perovskite solid electrolyte of claim 10, wherein the solid electrolyte has a high ionic conductivity of greater than 0.5 mS/cm at room temperature and greater than 1 mS/cm at elevated temperatures above approximately 40° C.

17. An anti-perovskite solid-state battery including the solid electrolyte of claim 10.
